(19) United States
(12) Patent Application Publication
(10) Pub. No.: US 2011/0298184 A1
(43) Pub. Date: Dec. 8, 2011

(54) O-Ring Apparatus With Integrated Tab and Method of Manufacturing Thereof

(76) Inventor: Lynn Aurelius, San Diego, CA (US)

(21) Appl. No.: 13/103,694

(22) Filed: May 9, 2011

Related U.S. Application Data
(60) Provisional application No. 61/332,559, filed on May 7, 2010.

(51) Int. Cl. F16J 15/02

(52) U.S. Cl. 277/630

(57) ABSTRACT

A tabbed O-ring, gasket or seal, made up of a shape such as a circumferential ring, and containing an integrated tab attached either on the outside of the seal, the inside of the seal, or attached both on the outside and inside of the seal, which facilitates the installation and removal of the tabbed O-ring for manufacturing and repair purposes.

### PRIORITY STATEMENT

This application claims the benefit of U.S. Provisional Application 61/332,559 filed May 7, 2010.

### FIELD OF INVENTION

The present invention relates to tabbed O-rings, seals or gaskets, and more particularly, the present invention relates to O-rings containing an integrated tab or flange for easier insertion and removal of the O-ring during installation or repair. Depending on the ultimate use of the O-ring, the integrated tab can be located on the outside or inside of the O-ring, depending on which location provides for the easiest removal. The tab can also be located on both the outside and inside of the O-ring.

### BACKGROUND OF THE INVENTION

In almost every mechanical or electrical component or device in which a gas or a fluid (and sometimes a solid) travels through or is contained, there can be leakage of that gas or fluid at the point that the component or device connects to or makes contact with another component or device.

In order to prevent the gas or fluid from escaping at the intersection of the two components, a rubber or plastic piece is inserted between the two components before they are connected or joined together. This rubber or plastic piece acts as a seal to prevent the gas or fluid from escaping at the connection. This seal, also known as a gasket or O-ring (due to its standard shape), is usually designed to be of a similar size as one or both of the components it is to be located between so as to minimize the size of the overall connection.

As an example, the design of a kitchen or bathroom faucet will undoubtedly utilize numerous O-rings or gaskets in order to prevent unwanted leakage of the faucet. By using O-rings between the incoming metal water hose and the metal faucet for example, the components can be made from a durable metal material without leaking water at the junction of the separate components.

O-rings can be made from many different materials and typically are manufactured using injection molding methods, but the manufacture of O-rings is not limited to injection molding technologies. Other manufacturing processes are known by those having ordinary skill in the art. Typically, materials used to make O-rings include polymer and thermoplastic mixtures (for example, polyurethane, latex, or elastomers, such as fluoroelastomers), natural or synthetic rubber (such as neoprene or chlorosulfonated polyethylene), among other materials. The material used to make the integrated tab on the O-ring can be the same as the material used to manufacture the O-ring itself, however, in certain instances, the integrated tab may be of a different, more durable material.

These seals or O-rings, because they are made of rubber or plastic, often wear out well before the other components, which are usually made of a more durable material such as metal. Because of their rubber or plastic material they are more likely to dry out, become brittle and crack over time. Often, the O-ring is compressed or squeezed during use in order to prevent leakage on the one hand, and to allow the passage of gas or liquid at other times. Again, this type of use decreases the useful life of the O-ring.

However, when the O-ring has reached the end of its useful life, the device it is installed in, such as the kitchen or bathroom faucet, may still be useful (except for the unwanted leaking). By replacing the O-ring or seal, the faucet once again provides the function it was meant to provide without the unwanted leaking.

However, because most O-rings are designed to fit inside or around a particularly shaped passageway, the O-ring is of minimal size in relation to the component or device it is being used with. Often, the O-ring fits exactly inside a hose or fitting, or is the same size diameter as the hose it is used in conjunction with. Since the O-ring may no longer be functioning as intended, it may have become dried out and brittle, or may have been deformed in use and no longer preventing gas or fluid from leaking. Once in this condition, removing the O-ring in order to replace it with a new one can become difficult. As such, there has always been a need for an easy and simple method to remove and replace an O-ring that is no longer functioning properly from a component or device.

For all of the above reasons, there is a need for a simple, inexpensive designed O-ring that will allow the O-ring to perform as necessary to prevent the leaking of gas or fluid, and provide an easier removal process of the malfunctioning O-ring, and an easier replacement of the new O-ring. The present invention satisfies this demand.

### SUMMARY OF THE INVENTION

The present invention solves all of the problems addressed herein by integrating a tab onto a seal, O-ring or gasket. Although the present invention can apply to any type of seal or gasket, the term O-ring is used throughout to refer to such seals or gaskets. O-rings can be manufactured in any size diameter and thickness and any shape as understood by those having ordinary skill in the art. However, a majority of O-rings are round in shape.

By providing an O-ring containing an integrated tab or flange, the device allows for easier insertion and removal of the O-ring during installation or repair. The integrated tab can be located on the outside or on the inside of the O-ring, depending on which location provides for the easiest removal and depending on the intended function of the O-ring. If necessary, the integrated tab can be located on both the outside and inside of the O-ring, or in multiple places on the edges of the O-ring.

As described herein, O-rings can be made from many different materials, such as polymer and thermoplastic mixtures, and typically O-rings are manufactured using injection molding methods along with other manufacturing methods. The material used to make the integrated tab on the O-ring can be the same as the material used to manufacture the O-ring itself, however, in certain instances, the integrated tab may be of a different, more durable material.

The present invention may be compounded with plastic or any polymer, for example, polyurethane, latex, or elastomers such as fluoroelastomers. It is also contemplated that the present invention may be compounded with rubber, natural or synthetic, such as neoprene or chlorosulfonated polyethylene, among others.

Based on the materials used and the manufacturing processes, an O-ring is manufactured in a way such that its costs to manufacture are pennies per piece or less. O-rings usually sell for less than a dollar in most hardware stores, although there are O-rings and seals that are much more expensive. As such, any attempt to create an O-ring that allows for easier insertion and removal should not increase the cost of manufacturing the O-ring by a significant amount.

As an example, in the pharmaceutical and nuclear labs industries, proper removal of an O-ring is critical in order to assure that a containment glove, which is considered part of a containment isolator or glovebox, is not breached. Over the past several years there has been a growing need for a product that facilitates removal of the O-rings that hold drybox gloves and sleeves in place, particularly when the person removing the O-ring is wearing one or more pair of gloves. By integrating a tab or pull-tab device onto the O-ring, the O-ring is easier to grip and remove from its grooves. The pull-tab is a safe device, which allows the user to remove the O-ring without destroying the glove that it is holding in place. The pull-tab also saves time because it is easy to grab without use of additional devices.

It is an objective of the present invention to provide an O-ring, gasket or seal containing an integrated tab or pull-tab such that the insertion or removal of the O-ring is facilitated by gripping the tab and pulling the O-ring from its location.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The invention can be better understood by reading the following detailed description of certain preferred embodiments, reference being made to the accompanying drawings in which:

FIG. 1 is a picture of an O-ring in accordance with the prior art;

FIG. 2 is a picture of an O-ring according to one embodiment of the present invention; and

FIG. 3 is a picture of an O-ring according to one embodiment of the present invention.

### DETAILED DESCRIPTION OF EMBODIMENTS OF THE INVENTION

The present invention is embodied by an O-ring, made up of a circumferential ring, and containing an integrated tab located either on the outside of the circumferential ring, the inside of the circumferential ring, or located both on the outside and inside of the circumferential ring.

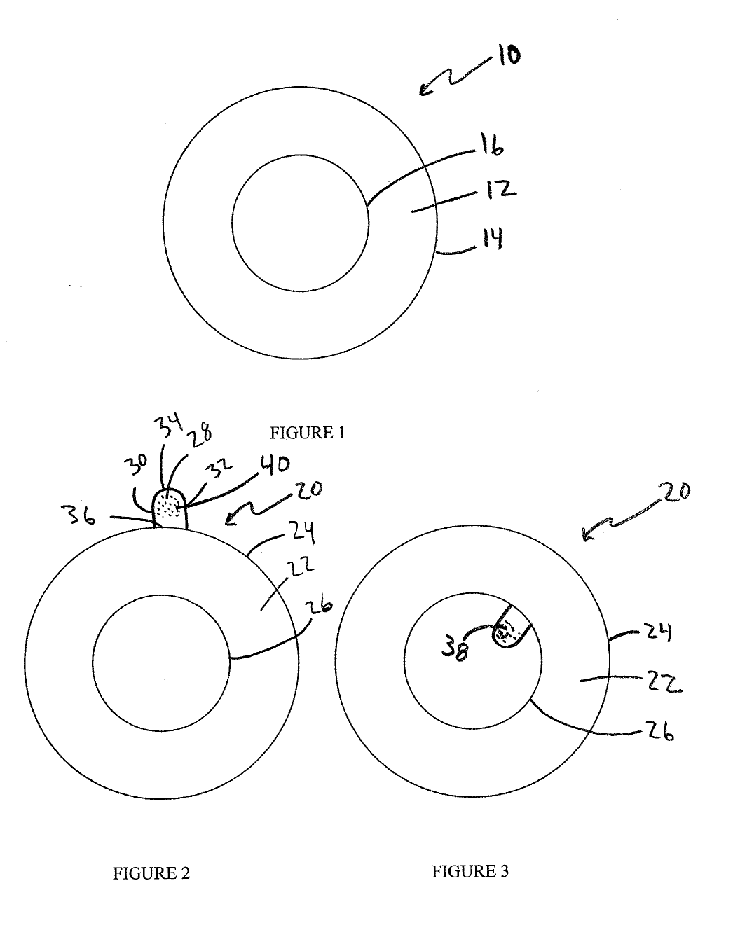

FIG. 1 shows an illustration of a seal, gasket or O-ring 10 as understood by a person of ordinary skill in the art. The O-ring 10 is made up of a circumferential ring 12, made up of one of numerous materials. The O-ring 10 can be made using polymer and thermoplastic mixtures, for example, polyurethane, latex, or elastomers such as fluoroelastomers. Other materials include rubber, natural or synthetic, such as neoprene or chlorosulfonated polyethylene, among others. As described herein, standard O-rings can be manufactured using various manufacturing processes, including injection-molding techniques, among others.

An O-ring can have numerous shapes, however, the most common shape is that of a circle, having an outer circumference 14 and an inner circumference 16, for which the diameter of the outer circumference 14 is larger than the diameter of the inner circumference 16. Usually these diameters do not vary throughout the circumferential ring 12. Of course, the shapes of the O-ring can vary, such as oval, square, rectangular or any non-standard shape necessary to fit an infinite number of components or devices. Further, the cross-sectional shape of the O-ring itself (not shown) can be circular, oval, square, rectangular or flat or any other shape as understood by those having ordinary skill in the art.

As described herein, an O-ring can be placed between to components or devices, such as a piece of conduit and a pump. Once placed between the two devices, the O-ring will prevent the fluid being pumped by the pump from leaking at the conduit/pump junction. However, when the O-ring has been deformed or is no longer useful, the conduit must be removed from the pump, and the O-ring must be replaced. To the extent the O-ring has been inserted into a channel at the junction, it may be difficult to remove the O-ring, especially if the O-ring has become dried out and brittle or has been ripped during use. Often a sharp object is used to remove the O-ring, which invariably gets cut up with some pieces remaining in the channel.

In order to obviate the difficulty in removing an O-ring from a component or device, the O-ring of the present invention contains one or more tabs or pull-tabs located on the outside, inside or in both locations of the O-ring. FIG. 2 shows the tabbed O-ring 20 of the present invention. For ease of reference, only one tab is shown, however, the present invention also pertains to multiple tabs located outside, inside or on both sides of the O-ring. Similar to a standard O-ring, the tabbed O-ring 20 has a circumferential ring 22, with an outside circumference 24 and an inside circumference 26. The outside circumference 24 has a diameter that is greater than the diameter of the inside circumference 26.

As with the standard O-ring 10, the tabbed O-ring 20 of the present invention can be manufactured using numerous techniques including injection-molding techniques, and can be manufactured with a variety of different materials, including polymer and thermoplastic mixtures, as described herein, and natural or synthetic rubber, among others. In the preferred embodiment, both the O-ring and the integrated tab are made of EPDM rubber (ethylene propylene diene Monomer (M-class)), and silicone (industrial grade and silicone USP VI for pharma use (both sterile and non-sterile)).

FIG. 2 illustrates the tabbed O-ring 20 in accordance with the preferred embodiment of the present invention. The tabbed O-ring 20 includes a tab or pull-tab 28 attached to the outside circumference 24 of the tabbed O-ring 20. The tab 28 can be located at any point on the outside circumference 24 of the circumferential ring 22, and can be any size (from edge 30 to edge 32), including from 1 to 25 percent of the diameter of the outside circumference 24; and can be any size (from top 34 to bottom 36), including from 10 to 20 percent of the diameter of the outside circumference 24. Of course, the size of the tab 28 can be greater or smaller depending on the use of the tabbed O-ring and/or depending on the use of the tab itself.

In the preferred embodiment, the O-ring 20 has a diameter of 7.725 inches and has a round cross section that is 0.210 inches in diameter. The tab 28 itself is 0.750 inches from top 34 to bottom 36 and 0.500 inches from one side 30 to the other side 32. The tab 28 of the preferred embodiment is curved at the top and may have dimples 40 on one or both sides for easier grasping. Further, the tab 28 may be thinner, thicker or the same thickness as the O-ring 20, however, in the preferred embodiment, the tab 28 is 0.100 inches thick. The thickness of the tab 28 depends on the particular design and functionality of the O-ring 20.

In the preferred embodiment, the tab 28 is formed or produced during the manufacturing process in which the O-ring 20 is manufactured. As described herein, the preferred manufacturing process for an O-ring 20 is the injection-molding process. Once the mold for the injection-molding process is created, the tab 28 can be produced using the same material as the O-ring 20. Further, the tab or pull-tab 28 can contain dimples 40 for a better grip.

Alternatively, the tab 28 can be formed separately and attached to the O-ring 20 using various methods. In this alternative process, the tab 28 can be the same material as the O-ring 20; however, it can also be a different material, possibly using a stronger material that does not have to have the same properties as the O-ring 20, such as flexibility and/or deformability. The tab 28 may be curved and have dimples for easier grasping whether it is made from the same material as the O-ring 20 or not.

FIG. 3 illustrates an alternative embodiment of the present invention in which the tabbed O-ring 20 has a tab 38 that is attached to the inside circumference 26 of the circumferential ring 22. As with the tabbed O-ring 20 containing a tab 28 on the outside circumference 24 in FIG. 2, the inside tab 38 can be made using the same manufacturing processes described herein and in particular with the outer tab 28; can be made from numerous materials, either similar to or different from the material used for the circumferential ring 22 as described above; and can have varying dimensions depending on the use of the O-ring 20 or the tab 38 itself.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A tabbed O-ring for preventing leakage between connected components, comprising a seal having an outer diameter and an inner diameter, such that said seal is designed to be placed between connected components in order to prevent leakage into and out of the connected components, said seal comprising an integrated tab, said integrated tab attached to said seal and configured to facilitate the removal of said seal from between said connected components.

2. The tabbed O-ring of claim 1, in which said integrated tab is attached to the outside of said seal.

3. The tabbed O-ring of claim 1, in which said integrated tab is attached to the inside of said seal.

4. The tabbed O-ring of claim 1, further comprising a second integrated tab, in which said integrated tab is attached to the outside of said seal, and said second integrated tab is attached to said inside of said seal.

5. The tabbed O-ring of claim 1, in which said seal is a circumferential ring.

6. The tabbed O-ring of claim 1, in which said seal is a rectangle.

7. The tabbed O-ring of claim 1, in which said seal is a square.

8. The tabbed O-ring of claim 1, in which said seal is not of a standard shape.
